(19) United States
(12) Patent Application Publication
(10) Pub. No.: US 2001/0008715 A1
(43) Pub. Date: Jul. 19, 2001

(54) CONTINUOUS TEXTURE FEATURES FOR A DISK SUBSTRATE

(76) Inventors: LI-JU LIN, SAN JOSE, CA (US); THOMAS ANTHONY O'DELL, CAMPBELL, CA (US); MARTIN P. ROSENBLUM, MENLO PARK, CA (US); TU CHEN, MONTE SERENO, CA (US); DAVID TREVES, PALO ALTO, CA (US)

Correspondence Address: KEITH G ASKOFF, KOMAG INC, 1704 AUTOMATION PARKWAY, SAN JOSE, CA, 95131

(21) Appl. No.: 09/216,008

(22) Filed: Dec. 17, 1998

(51) Int. Cl. G11B 5/64; G11B 5/82

(52) U.S. Cl. 428/694 TR

(57) ABSTRACT

A method for texturing a substrate and the resulting substrate. A substrate made of glass ceramic is textured using laser radiation to form a texture feature. The laser radiation may be applied with a degree of overlap. Additionally, the texture feature may be elongated or continuous in the circumferential direction. The radiation is applied such that the texture feature has smaller texture features formed thereon.

### FIELD OF THE INVENTION

The present invention relates to hard disk drives used to store data, and more particularly to a method of and apparatus for texturing a substrate and the resulting substrate.

### BACKGROUND OF INVENTION

In the field of hard disk storage systems, continuous improvements have been made in increasing the areal density, i.e., the number of stored bits per unit of surface area. As is well known, decreasing the fly height of the magnetic recording head results in reduced pulse width (PW50) due to a number of factors which allows for greater recording density. For a discussion of the effects of lower fly height, see, for example, U.S. Pat. No. 5,673,156. In any event, bringing the head closer to the media has been a key area of effort in increasing recording densities.

The magnetic recording head (which as used herein shall mean any device which flies over a disk to write data to and/or read data from the disk) is typically a part of or affixed to a larger body that flies over the disk and is typically referred to as a “slider”. The slider typically comprises one or more rails that undergo sliding contact with a portion of the disk whenever the drive motor is turned on or off. This contact between the slider and the disk occurring when the drive is turned on and off is known as contact start stop (CSS) operation and occurs on a portion of the disk referred to as the “CSS zone” or the “landing zone.”

The CSS motion between the slider and the disk is of great concern in the reliability of the drive since it is generally the major initiator of failure in hard disk drives. In today's commercially available disk drives, generally 20,000 CSS cycles for desk-top computer applications and up to 100,000 CSS cycles for portable or hand-held computer applications is considered adequate. To achieve the above mentioned lower fly heights, it is necessary to reduce the glide avalanche height (height at which the slider undergoes substantially constant contact with the surface) of both the CSS zone and the data zone. Although the avalanche height of the CSS zone can permissibly be greater than that of the data zone, it is desirable to minimize the avalanche height of the CSS zone to reduce head to media interference when the head flies from the data zone to the CSS zone to thereby ensure the mechanical reliability of the drive. The reduced glide avalanche requirements for the CSS zone make it extremely difficult to achieve acceptable stiction performance.

Stiction is a term used to describe the force exerted against the motion of the slider relative to the disk surface when the slider is at rest on the disk surface. Stiction values are often given in grams to represent the force required to separate the slider from the disk. As is well known, the surface of magnetic disks are covered with a hard overcoat such as sputtered carbon or chemical vapor deposition (CVD) carbon and with lubricant to enhance the wear performance. It is desirable for the surface to retain a quantity of lubricant to provide for reduced wear over time and improve the lifetime of the disk drive. However, the stiction is greatly increased if the lubricant wets a significant portion of the slider/disk interface due to the meniscus force.

Stiction may be tested by performing repeated CSS operations in the landing zone. Typically, testing is performed over numerous cycles. The term “initial stiction” is used to refer to the first CSS operation (or first few CSS operations) in a series of numerous CSS operations. These first few CSS operations typically show the lowest stiction because there has not been significant wear of the disk surface. After repeated CSS operations on the same track, some wear occurs and the stiction becomes “modulated”—that is, the stiction increases. The stiction may be measured under more rigorous conditions. For example, parking stiction is a term used when the slider has been at rest for some time (e.g. a few hours or a few days) on a portion of the CSS zone that has undergone extensive CSS cycles. The parking allows for some lubricant migration to the interface. Parking stiction is typically much greater than stiction resulting from successive CSS operations without parking time in-between because of the lubricant migration to the interface and because of slight wear of the high points in the CSS zone. Finally, the term fly stiction is used to describe the situation where the slider has flown over the data zone of the disk for a considerable amount of time so as to pick up lubricant, and then has returned to the CSS zone and has remained parked on the disk surface for a sufficient time (e.g. several hours to a few days) to allow the lubricant to flow to and significantly wet the interface, thereby greatly increasing stiction. In the very low fly height drives of the future the pick up of lubricant in the data zone and consequent increase of stiction in the CSS zone will be even more severe. It will be appreciated that the foregoing terms are general in nature and the terminology and test criteria by which stiction is measured vary considerably.

As mentioned above, stiction can be reduced by putting a texture on the disk surface in the CSS zone to reduce the effective contact area between the slider and the disk. In effect, a rougher texture and modification of texture morphology is needed to achieve acceptable CSS performance. Texture is generally believed to reduce stiction by reducing the total contact area between the head and the disk. However, the above described reduced avalanche height requirements limit the allowable maximum roughness of the texture or height of texture features. Therefore, maintaining acceptable stiction performance within the glide avalanche height of advance devices has become increasingly challenging.

The texture pattern may be put on the disk by mechanically abrading the substrate surface using well known methods. Another known method to provide the necessary texture in the CSS zone is laser zone texturing. This method is described in U.S. Pat. Nos. 5,062,021 and 5,108,781, both to Rajan et al. In such a method, a laser beam is focused to a small spot on the disk surface, forming uniformly shaped and sized features in a controllable pattern. Because of the high degree of control possible with a laser system, the CSS zone can be precisely delineated so that any loss of area for storing data can be minimized.

The above referenced U.S. Pat. Nos. 5,062,021 and 5,108,781 teach texturing of a NiP layer on an aluminum substrate. However, it is also known in the art to use substrate materials of, for example, glass ceramic. As used in the present application, glass ceramic shall refer to any glass based material that is partially or entirely crystallized, or that is capable of becoming partially or completely crystallized upon appropriate heat treatment. It is desirable to use glass ceramic because it is more resistant to deformation upon sudden head slap by the recording head than NiP plated aluminum.

Laser texturing of glass ceramic has proved somewhat problematic. One problem is that most glass ceramic materials are transparent to the wavelengths of laser radiation in commonly available commercial systems. U.S. Pat. No. 5,741,560 teaches an alternative method comprising depositing a metallic initiation layer on a glass substrate, plating a NiP layer onto the substrate, and then laser texturing the NiP layer. In this way, the disk can be textured much the same way as conventional aluminum disks with NiP layers. Although this method is effective, it requires additional processing steps as compared with texturing the glass ceramic substrate directly. Other methods of texturing a glass ceramic substrate include using a different wavelength (depending upon the absorbtion edge) than that which is used for texturing for example, NiP. In some cases the laser texturing process has been insufficiently controllable for a production use due to ablation of the substrate surface.

Teng et al. in “Laser Zone Texture on Alternative Substrate Disks,” IEEE Trans. on Magnetics, Vol. 32, No. 5, pp. 3759-3761 (September 1996), discuss laser texturing glass ceramic substrates with a CO₂ laser. The CO₂ laser uses a longer wavelength of radiation than that typically used for texturing NiP. The resulting texture reported in Teng's article show smooth bump shaped protrusions that extend approximately 30 nanometers (nm) from the surface of the glass ceramic substrate, and are about 15-20 micrometers (μm) wide at the base. U.S. Pat. No. 5,595,791 to Baumgart et al. also describes a method of texturing a glass substrate using a CO₂ laser. Energy fluence of each laser pulse is controlled such that it is below what is termed a “thermal shock threshold” which causes stress in the substrate causing the surface to crack and break up. Additionally, the fluence is caused to be above the melting or softening point of the material in order to form the texture feature. The '791 patent notes that the bumps formed therein are very smooth and comprise only positive protrusions from the substrate surface due to the nonconservation of volume. The smooth bump formation shown in Teng et al. is the result of use of excessive laser energy which not only melts the glass phase but also melts the crystalline phase and causes it to become an amorphous glassy structure during quick cooling.

The laser texture on NiP plated aluminum substrate has been successfully commercialized for several years. However, to date the texture pattern used is discrete laser bumps formed in a spiral or concentric pattern. One problem that may occur with discrete laser bumps is that a resonance condition may result in the excitation of the slider body by the periodic nature of the laser bump pattern. This problem is discussed in the Yao et al. in “Head-Disc Dynamics Of Low Resonance Laser Textures—A Spectrogram Analysis” IEEE Trans. on Magnetics, Vol. 34, No. 4, pp. 1699-1701 (July 1998). Yao et al. describe that random patterns of bumps may be used to minimize the problem, or a spiral line feature may be used to practically eliminate resonance. However, one problem with spiral line type features where the bump surface is smooth is that the surface area of contact between the disk and the slider is greatly increased as compared with bump type features, thereby greatly increasing the stiction.

In patent application Ser. No. 08/911,817, filed Aug. 15, 1997 which application is assigned to the Assignee of the present invention, and which application is hereby incorporated by reference, a method of texturing a glass ceramic substrate is taught wherein the texture bumps have smaller, spike-like features formed thereon. Because of these spike-like features, the contact area between the slider and the bump is reduced compared with the smooth bumps of Teng, thereby reducing the stiction. Kuo et al. in “Laser Zone Texturing On Glass And Glass Ceramic Substrates” IEEE Trans. on Magnetics, Vol. 33, No. 1, pp. 944-949 (January 1997) note that an added topography feature of a rough top formed over dome shaped bumps may occur on laser textured glass ceramics under certain conditions. However, Kuo et al. do not recognize that this topography feature is of any particular use.

### SUMMARY OF THE INVENTION

The present invention teaches methods for texturing a substrate used to make magnetic recording media, such as a glass ceramic substrate. A radiation pulse is applied to the surface of the substrate under conditions causing a protrusion to form. Some embodiments comprise forming texture features such that there is a certain degree of overlap between laser exposure of adjacent features. The features may be formed under conditions that cause smaller, spike-like features or micro-texture to be formed on the protrusion to provide superior CSS stiction performance as more fully described herein. The pulse is applied in some embodiments to cause the protrusion to be substantially continuous for some distance along the circumferential direction of the substrate. In other embodiments discrete bumps (in ordered or in random patterns) can be formed.

The present invention comprises a substrate having texture features, whether discrete bumps, elongated or continuous features, or other shape having a certain degree of overlap between adjacent features. Substrates having texture features comprising substantially continuous protrusions and texture features having smaller, spike-like features thereon to achieve good CSS stiction performance are also disclosed.

Additional embodiments and other features and advantages of the present invention will become apparent from the detailed description, figures and claims which follow.

### BRIEF DESCRIPTION OF THE DRAWINGS

FIG. 1 illustrates stiction results for several different pattern densities of discrete texture features with spike like micro-texture formed on a glass ceramic substrate.

FIG. 2 shows an atomic force microscope (AFM) image of a texture feature according to an embodiment of the present invention formed on a glass ceramic substrate.

FIGS. 3A to 3E illustrate stiction results on glass ceramic substrates textured with continuous features by a method according to an embodiment of the present invention.

FIG. 4 illustrates stiction results on a glass ceramic substrate textured with continuous features according to an embodiment of the present invention, for various radial spacings.

FIG. 5 shows a profile of continuous texture features formed with some overlap of laser incidence between adjacent features (20 μm spacing).

FIG. 6 shows a profile of features formed with a lesser degree of overlap than that shown in FIG. 5 (30 μm spacing).

FIG. 7 shows a profile of features formed with a greater degree of overlap than that shown in FIG. 5 (10 μm spacing).

FIG. 8A shows a three dimensional AFM image of discrete texture features formed with overlap of laser incidence.

FIG. 8B shows a two dimensional profile of a portion of the surface shown in FIG. 8A.

FIG. 9 shows stiction results for the texture of FIG. 8 and for a second pattern of features having a greater spacing than that shown in FIG. 8.

FIG. 10 shows fly stiction results for three 20×20 patterns of discrete texture features formed by different processes (pulse width and pulse energy).

FIGS. 11A and 11B show two dimensional profiles of discrete texture features formed using different pulse widths.

### DETAILED DESCRIPTION

A method of texturing a glass ceramic substrate, and a textured substrate are disclosed. In the following description, numerous specific details are set forth such as specific substrates, materials, laser types and operating parameters, feature dimensions, etc. It will be appreciated, however, that these specific details need not be employed to practice the present invention. In other instances, well known methods and apparatuses are not described in detail in order not to obscure unnecessarily the present invention.

In the present invention, a substrate is textured, according to the method described herein, by direct irradiation with, e.g. a laser. The substrate may comprise glass ceramic and may be, for example, glass ceramic no. TS-10 IV C SP, TS-10 BU or TS-10 SX SP, or others available from Ohara Ltd. of Japan. The substrate may also be glass ceramic sold under the trade name MOD-AL sold by Raychem Corporation of Menlo Park, Calif. As a further example, a glass ceramic material sold under the trade name FOTURAN is available from Schott Glasswork of Germany. Glass ceramic substrates such as these referred to as M4 and M6 may be obtained from NGK of Japan. Although the term substrate is often used in the industry to denote the starting workpiece used to form a magnetic recording disk, it will be understood that the term “substrate” as used herein shall have a more general, broad definition including any workpiece (which may include layers formed or deposited thereon, such as layers which form part of a magnetic recording disk) upon which the described methods may be performed or on which the described structures may be formed.

Other types of glass ceramic can also be used. Glass ceramic materials are discussed by G. H. Beall in “Design and Properties of Glass-Ceramics”, Review Material Science, pp. 91-119, Vol. 22, 1992, incorporated by reference. Other glass ceramic materials are discussed by Jastrzebski, “The Nature and Properties of Engineering Materials”, 2nd edition, published by John Wiley & Sons, 1976, p. 368 et seq., incorporated by reference. Also see U.S. Pat. No. 4,386,162 and European Patent Application 0 384 574 A2, incorporated herein by reference.

As discussed in Teng et al., the prior art teaches laser texturing of a glass ceramic substrate using laser parameters sufficient to locally melt the substrate thereby transforming it to an amorphous phase in the locally melted region which appears to undergo volume expansion and/or stress relief causing the domed bump formation. Such bumps of amorphous material have a relatively smooth profile.

In contrast, the method of the present invention (as more fully described in the aforementioned patent application Ser. No. 08/911,817) recognizes that by proper selection of laser parameters (e.g. wavelength, power, pulse duration and energy), the bumps may be formed with smaller texture features formed on the bumps having a spiked appearance. Typically, the width of the smaller features is significantly less than the width of the bump (for example, the bumps may have an average width in the range of approximately 1-30 μm from their base, while the smaller features formed on the bump may have an average width in the range of approximately 0.05-3 μm at the base). The height of the smaller features as measured from their base on the larger features is roughly within the same-order of magnitude as the bump height (for example, the average height of the smaller features may be in the range of approximately 10-200 Å). It will be appreciated that the dimensions described herein are merely exemplary and features having other dimensions may be formed. For purposes of discussion, the large, positive protrusion from the surface that corresponds roughly to the prior art texture feature will be referred to as a “texture feature,” or a “bump,” or a “protrusion.” The smaller features will be referred to as a “micro-texture,” or “small texture features.”

Although not wishing to be bound by theory, it is believed that the unique surface texture is achieved by applying the laser pulse such that the substrate is locally heated to a temperature sufficient to cause softening or melting of the glass phase, but using conditions such that at least some of the crystalline phase is not melted—i.e., substantially complete melting of the substrate material in the heated area around the beam center does not occur. It is believed that by heating in accordance with the foregoing, stress is relieved and positive protrusions are formed and further, the crystallites present in the material “break through” the partially melted or softened material near the surface and stand out to form the micro-texture.

In contrast, it is believed that the prior art method as described by Teng et al. completely melts the glass as well as the crystallites, resulting in smooth bump surfaces. It will be appreciated that other or different processes may occur in the present invention. For example some vitrification or devitrification may occur on a localized scale. It has been found that as with the prior art, applying a greater amount of energy results in larger protrusions (i.e. greater bump height). In general, however, it has been found by us that exposure to radiation at higher powers for a short duration as opposed to lower powers at greater duration provides the micro-texture of the present invention. It is believed that longer, lower power radiation may allow the surface to locally come to equilibrium with the result that substantially all material melts and becomes smooth.

In one example, laser texture may be applied by rotating a substrate at a speed in the range of approximately 500-4000 rpm for linear velocities at the point of incidence of the laser beam on the substrate surface (“linear velocity”) typically in the range of approximately less than 1 meter per second (m/s)—9 m/s, while pulsing the laser typically in the range of between 0.1 microsecond (μs) and 40 μs. A pattern of discrete features, such as a concentric circle pattern, a semi-circle pattern, or a spiral pattern of discrete features may be formed by virtue of the rotation of the substrate together with either radial movement of the substrate or movement of the laser itself or the optics. It will be appreciated that any scheme of substrate motion, laser motion, and optics motion may be used to achieve the desired pattern. In any event, when the duration of the laser pulse is relatively short the laser bumps are substantially circular in shape by virtue of the minimal movement of the substrate during the period the laser is on.

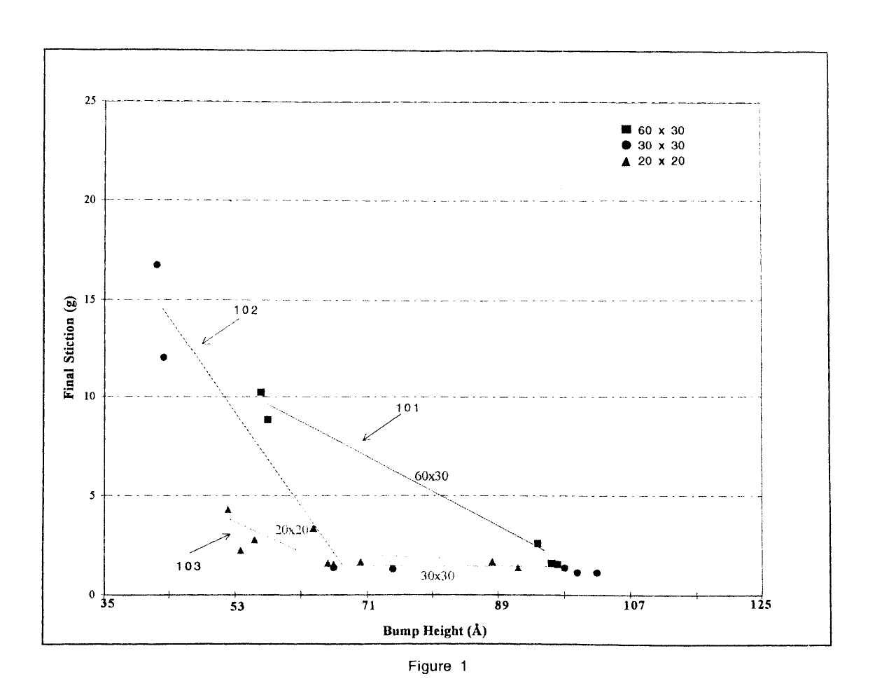

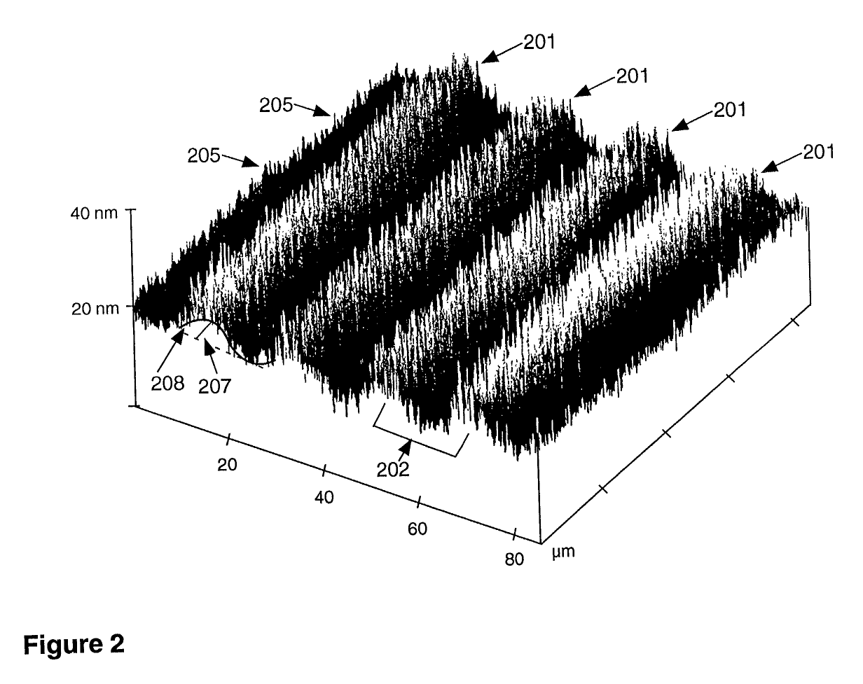

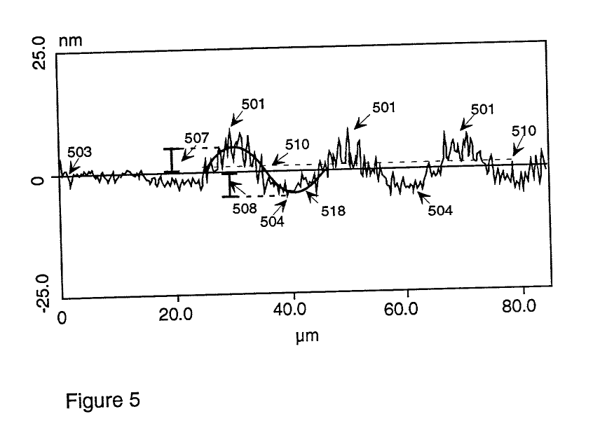

FIG. 1 shows stiction results for three different pattern densities of discrete laser bumps formed on an 84 millimeter (nm) TS-10 IV C SP glass ceramic substrate (available from Ohara). The laser bumps in FIG. 1 were formed with the previously described micro-texture by the method described in the aforementioned patent application Ser. No. 08/911,817. Shown along the X axis is the bump height, in angstroms as measured by MicroXAM™ interferrometric microscope available from Phase Shift Corporation. It will be appreciated that discussion of bump height must be considered in the context of the morphology of the bumps, measurement method and various definitional issues. Certain aspects of bump height and surface morphology will be discussed in more detail below, particularly in conjunction with FIG. 2 and FIG. 5.

In FIG. 1, the Y axis shows the final stiction in grams. Final stiction refers to the stiction after some number (e.g. 10,000) of CSS cycles. The stiction results shown in FIG. 1 are for hot (55° C.), dry (10% relative humidity) conditions. The laser bumps in FIG. 1 were generated using a 4 μs pulse width and a 20 μm full width at half maximum (FWHM) spot size. With respect to pulse width, the CO₂ laser used in the embodiments described herein is a continuous and not a pulsed laser. Therefore, the term pulse width as used in these embodiments refers to the length of time the laser beam is directed to the substrate surface rather than a pulse duration of the laser itself.

Each of the Curves 101-103 comprises features formed using the above pulse width, spot size and linear velocity and two (Curve 101) or three (Curves 102 and 103) different energy levels to form two or three different sets of bump heights, as measured by MicroXAM™. For Curve 101 the energy used was approximately 7.40 micro Joules (μJ) to form the bumps of approximately 60 Å, and 7.76 μJ to form the bumps of approximately 100 Å. For Curve 102 the bumps of approximately 40 Å, 70 Å, and 100 Å were formed using energies of 7.22 μJ, 7.40 μJ and 7.76 μJ, respectively. Finally, for Curve 103, the bumps of approximately 50 Å, 65 Å and 90 Å were formed using energies of 7.22 μJ, 7.40 μJ and 7.76 μJ, respectively. The energy is the product of the power applied times the pulse width. Within a typical range of interest, greater energies result in greater bump height, but the relationship is not linear and the slope of the energy versus height curve varies depending upon the operating range. In addition, the curve will be different for different power levels or differences in other parameters or substrate materials. It will be appreciated that one of skill in the art understands these effects and in designing a process to achieve a desired bump height and other characteristics can perform some experimentation within a range of power, pulse width, substrate speed, spot size and other parameters or conditions.

The line 101 shows the results for a 60×30 pattern. The first number refers to the spacing of the bumps in the circumferential direction, while the second number refers to the spacing of the bumps in the radial direction, both in micrometers. Curve 102 shows the stiction results for a 30×30 pattern of bumps, while line 103 shows stiction results for a 20×20 pattern. As shown by line 101, the 60×30 pattern results in unacceptably high stiction even at relatively high values of bump height (and therefore relatively high glide avalanche height). In contrast, as shown by line 102 the 30×30 pattern maintains very good stiction results below 70 Å bump height. Finally, as shown by line 103, the 20×20 pattern maintains much lower stiction values to about 50 Å bump height. As is well known, low stiction at low glide avalanche height is necessary for advanced high density devices. As will be described in more detail later, the 20×20 pattern is formed with a certain overlap between the laser incidence which creates a negative depression and a consequent increase in the effective bump height at low glide avalanche.

In accordance with one embodiment of the present invention, the texture features of the present invention are formed in an elongated manner in the circumferential direction. That is, in contrast to substantially round or bump shaped discrete features, the texture features of this embodiment of the present invention have a width in the radial direction that may be on the order of typical diameters of the laser beam (FWHM), but a length in the circumferential direction extending for a significantly greater distance than the width. In this regard, the texture features may be substantially continuous for some portion or all of, e.g., a concentric ring, a semi-circular ring or spiral pattern.

Referring to FIG. 2, an embodiment of the present invention is shown. The view of FIG. 2 shows an approximately 80 μm×80 μm portion of the CSS region of the substrate. Laser texture feature 201 is part of a continuous track formed in a spiral pattern in the CSS zone. As can be seen from the figure, the radial spacing 202 is approximately 20 μm. Unlike conventional discrete laser bumps, there is no circumferential spacing because the feature is continuous. Moreover, the small texture features 205 formed on the larger features 201 can readily be seen.

The features of FIG. 2 were formed on an Ohara TS-10 IV C SP substrate using a CO₂ laser having a wavelength of approximately 10.6 μm, a beam diameter of approximately 20 μm (FWHM) at a beam power of approximately 2 watts. The substrate was rotating at an rpm such that the linear velocity was approximately 6 m/s. It will readily be appreciated that the foregoing parameters are merely exemplary, and that significantly different parameters may be used based upon the specific substrate, laser system, desired bump height, etc. In the embodiment shown in FIG. 2, the laser was left on continuously for the formation of the entire spiral track in the CSS zone. That is, the beam is directed at the substrate surface for the duration of CSS texturing. In this case, the control of the total energy applied to a given portion of the surface, and rate at which the energy is applied is controlled by the power level and rotation speed.

As can be seen from FIG. 2, the surface comprises numerous jagged spikes. Because of this, the surface level can vary greatly from one location to the next. A “smoothed” profile 208 as shown in the Figure represents an approximate “local average surface level.” In general, the MicroXam™ measurement of bump height is representative of the average surface, so that unless otherwise noted, the approximate dimensions of the texture features reported herein are based upon the local average surface level rather than upon specific points on the surface. Moreover, as will be described more fully herein, embodiments of the present invention, including that shown in FIG. 2, comprise both positive protrusions and negative depressions. However, the bump height as measured by MicroXam™ is approximately the height of the positive protrusions only. Therefore, the effective height for these embodiments is greater than the bump height as measured by MicroXam™. Unless otherwise noted, bump height represented herein is the height as measured by MicroXam™. In the case of FIG. 2, the measured bump height was approximately 74 Å. However the “effective” height (total hill to valley height) of the texture features 201 illustrated by line 207, is greater than this as will be described in more detail in relation to FIG. 5.

The small features 205 may have a broad range of dimensions but in general may have an average diameter at their base in the range of approximately 0.05-3 μm wide, and average heights from their base in the range of about 10-200 Å. The small features 205 are formed in the manner described in the aforementioned patent application Ser. No. 08/911,817, and the considerations described therein apply to the present invention as well.

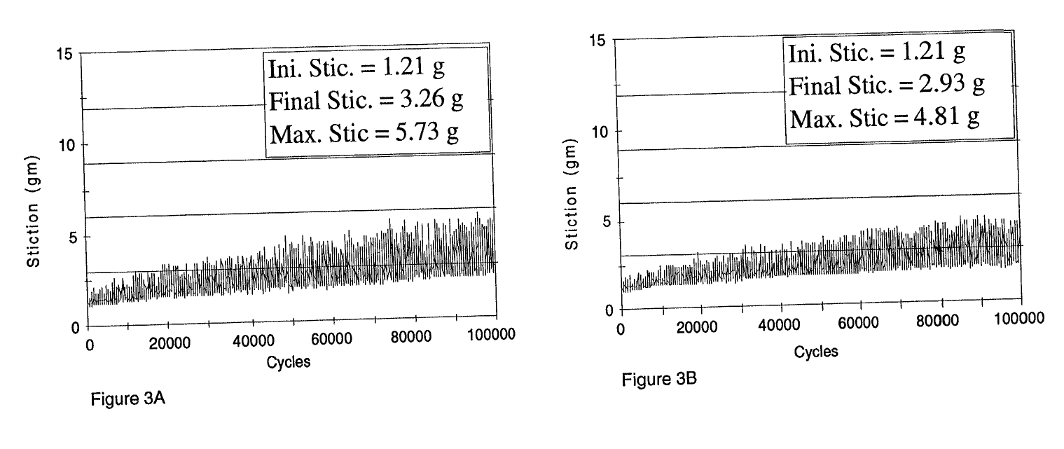

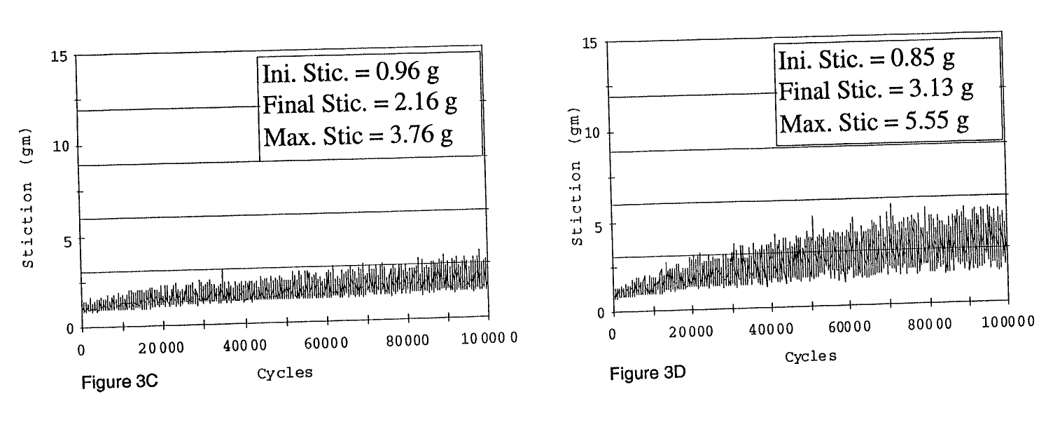

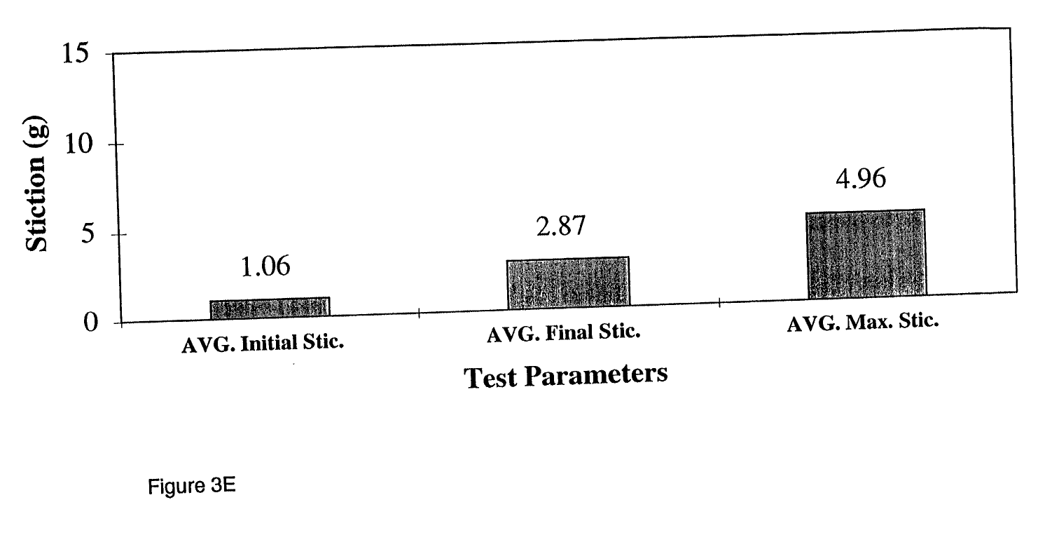

FIGS. 3A through 3D show stiction results for continuous texture features with a radial spacing of 20 μm and a bump height of approximately 70 Å. The substrates were Ohara TS-10 IV C SP. The features were formed using a beam power of approximately 1.25 watts, spot size of 20 μm FWHM with the disk rotating such that the linear velocity was approximately 6 m/s. The texture features further have the micro-texture described herein having dimensions similar to those discussed in conjunction with the features 205 of FIG. 2. The glide avalanche in the textured area for the texture shown in FIG. 2 is in the range of approximately 0.6-0.7 μ″. The glide avalanche depends on the particular surface morphology, including the height of the bumps, the height and number of small texture features and the average surface height the air bearing surface “sees” as it flies over the disk. As will be described in more detail later the present invention provides for improved stiction performance at low glide avalanche due to the increased “effective” height of the features. In addition, the additional roughness imparted by the micro-texture of the present invention allows for use of smaller bump heights (i.e. heights of the large protrusions) than would be required if no micro-texture were present, to achieve comparable stiction results.

On the X axis of FIGS. 3A through 3D, the number of CSS cycles is shown. The Y axis shows stiction in grams. Often, testing is performed for approximately 10,000 or 20,000 CSS cycles. In contrast, FIGS. 3A through 3D show extended testing through 100,000 CSS cycles. The tests were performed at ambient conditions and the stiction was measured after each CSS cycle in the series of sequential cycles. FIGS. 3A through 3D show four different disks and four different heads with the above described texture feature. As is expected, the stiction increases over the number of CSS cycles as indicated by the increase in the stiction modulation envelope. This increase, as described earlier, is due to head-disk interface degradation. Importantly, however, the stiction still remains within acceptable limits even after 100,000 cycles. This is significant, in that the aforementioned glide avalanche of approximately 0.6-0.7 μ″ is typical of the demands for glide avalanche height for advanced devices. FIG. 3E shows the average results for the textured substrates of FIGS. 3A-3D. In the context of FIG. 3E, initial stiction refers to the first CSS cycle tested, final stiction refers to the stiction of the last CSS cycle tested, and maximum stiction refers to the maximum stiction of any CSS cycle of the 100,000 tested. As can be seen from FIG. 3E, the results in the disks of FIGS. 3A through 3D show excellent stiction performance even after significant use.

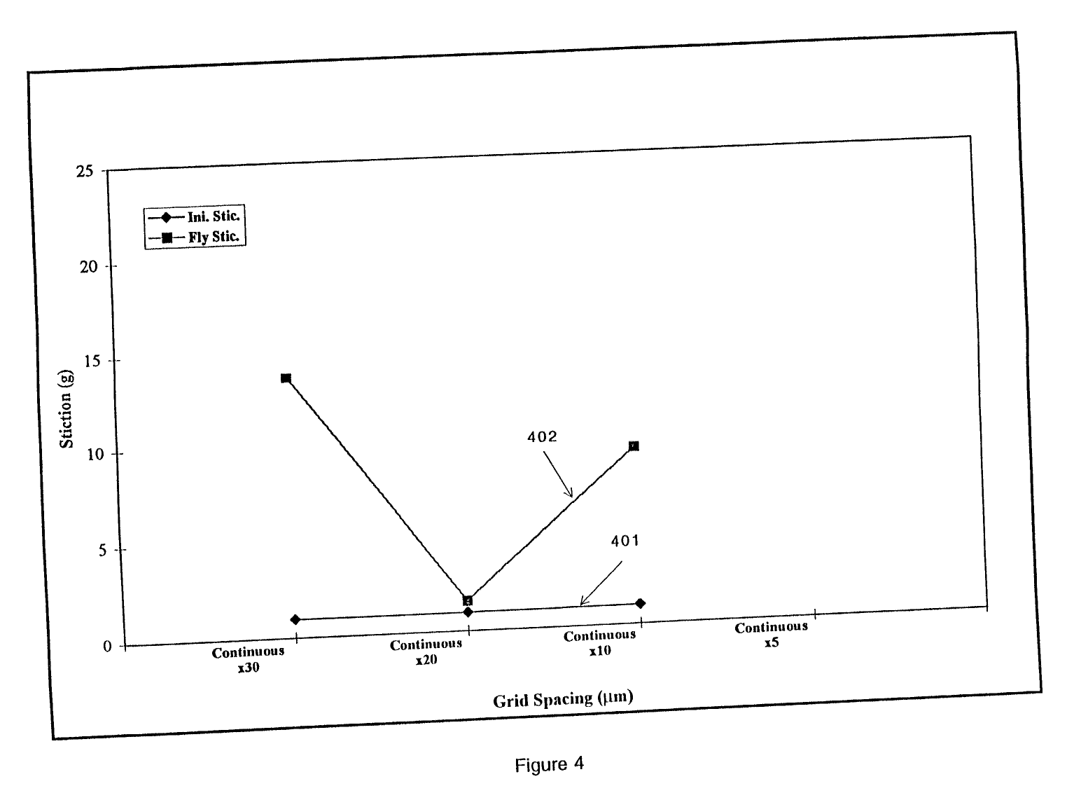

FIG. 4 shows the effect of radial spacing of the texture features on stiction performance for continuous features in accordance with an embodiment of the present invention. In FIG. 4, different radial spacings of the continuous texture features are shown along the X axis. The Y axis shows stiction in grams. Line 401 shows the results for initial stiction (i.e. the stiction of the first few CSS cycles, without flying over the data zone or parking on the CSS zone prior to measuring stiction). Line 402 shows the stiction results for fly stiction (i.e. the stiction results after flying over the data zone for 72 hours, and then parking on the CSS zone for 24 hours prior to CSS testing. As shown by line 401, the initial stiction remains at very low levels over a range of radial spacings. Because fly stiction is much more rigorous testing, the fly stiction performance as shown by line 402 is more sensitive to radial spacing. The results in FIG. 4 were obtained using a Ohara TS-10 IV C SP mm diameter glass ceramic substrate using a beam power of approximately 1.25 watts, a spot size of approximately 20 μm FWHM, with the disk rotating such that the linear velocity was approximately 6 m/s. The bump height was approximately 70 Å and the glide avalanche height was approximately 0.6-0.7 μ″.

FIG. 4 thus illustrates that in some cases there is an optimum radial spacing for the texture features to achieve minimum fly stiction results. The optimum radial spacing may differ from that shown in FIG. 4 for a given set of conditions depending upon the protrusion height, the particular morphology of the micro-texture, the slider, the lubricant and other factors. The optimum for any given set of conditions may readily be determined by testing stiction performance at a variety of radial spacings in the manner shown in FIG. 4. The minimum stiction at 20 μm radial spacing is believed to be due to the partial overlap of the laser beam during texturing as is described in more detail immediately below.

Embodiments of the present invention comprise forming texture features on a glass ceramic substrate such that there is some degree of overlap of the laser beam profile, in either or both the radial and circumferential direction, during formation of a feature and a subsequently formed feature. That is, a portion of the surface irradiated during formation of a first feature is re-irradiated during the formation of a subsequent, adjacent (either or both radially or circumferentially) feature. Although laser texture is known to produce the positive protrusions described generally herein, we have discovered that this overlap can create a wave-like surface, having both positive and negative extending portions from an average level. In an embodiment using overlap, the laser texture features may be discrete or continuous.

A benefit of the present invention may be seen by reference to FIG. 5 which shows continuous texture features formed in accordance with an embodiment of the present invention. The texture features were formed at a radial spacing of 20 μm on an Ohara TS-10 IV G SP substrate. The beam power was approximately 1.25 watts, and the beam diameter was 20 μm FWHM. An approximate average surface level is shown by smooth curve 518 for a portion of the profile. This smooth profile 518 is used to determine approximate dimensions as shown in the figure and discussed immediately below. The positive portions of protrusions 501 have a height 507 above the level of the untextured surface 503 (corresponding to the data zone) of approximately 70 Å and a width (as measured between the intersections of the smooth profile 518 with the surface level 503) of approximately 10 μm. The depressions 504 between the positive protrusions 501 have a depth 508 below the level of the surface 503 of approximately 40-50 Å.

With respect to stiction performance, the “effective” height of the features is equal to the height 507 above the level of the surface 503 plus the distance 508 below the level of the surface 503, or in the case of FIG. 5 approximately 120 Å. Thus, the effective texture feature height in terms of stiction performance includes the entire hill to valley distance between the peaks and valleys of the features and therefore is much greater than the height of the positive protrusion 501 alone.

However, glide avalanche height is determined as the distance above the average surface level at which substantially continuous contact occurs. For prior art spaced features, with no overlap, the average surface level is the average of the height of the untextured surface and the height of the features. Because most of the surface area is untextured, the average surface level is just slightly above the level of the untextured surface. For such a surface, the glide avalanche is therefore approximately proportional to the total height of the texture features. In contrast, in embodiments of the present invention using overlap, the average surface level is raised to the line 510 such that the glide avalanche is essentially proportional to that portion of the height of protrusions 501 above the average surface level 510 (i.e. approximately 70 Å for the embodiment of FIG. 5), which is significantly less than the total effective height in terms of stiction reduction of 507 plus 508 (i.e. 120 Å in this embodiment). Therefore, the overlap of the present invention allows for reduced glide avalanche height as compared with non-overlapping features having equivalent stiction performance. Of course, as mentioned earlier, the glide avalanche will depend upon the particular morphology, including the height and number of micro-texture features. Nevertheless, for a given morphology the increased effective height achieved by the use of overlap is beneficial.

The present invention provides for improved fly stiction performance while allowing for lower glide avalanche height in the CSS zone as compared with features that do not overlap. This is believed to be due to the depressions 504 between protrusions 501 which provide a “reservoir” area for lubricant that may have been picked up by the head (e.g. while flying over the data zone in a low fly height drive) to flow to upon contacting the CSS region. The protrusions 501 having micro-texture 205 provide numerous, relatively closely spaced point contacts which prevent a large meniscus from forming while the depressions 504 provide this reservoir for lube. Conversely, the fly stiction has been found to increase where the features are too closely spaced as well. This may be due to the fact that the protrusions 501 essentially merge and substantially reduce the depth of depressions 504 (as will be discussed in more detail below), thereby reducing the aforementioned reservoir for lubricant. Additionally, such merger in effect decreases the effective height of the protrusions (e.g. distance 507 plus 508 of FIG. 5) which as described earlier provides improved stiction performance for a given glide avalanche.

A further benefit can be seen from FIG. 5. As described in the background section, in the prior art it has been found that in laser texturing glass and glass ceramic, volume is not conserved, and texture features comprise positive protrusions from the substrate surface with no corresponding volume extending below the surface level. As shown in FIG. 5, by overlapping the features the depressions 504 are created and extend a distance 508 below surface level 503. Therefore, the peaks 501 extend a lesser height above data surface 503 than texture features having a height equivalent to distances 508 plus 507 extending from the surface level. This is beneficial because texture features of reduced height in respect to the data surface allow lower avalanche as described above and moreover reduce head media interference and hence cause less wear and potential for damage as the head moves between the data zone to the CSS zone—that is moves from flying over surface 503 to flying over positive protrusions 501.

It is believed that the creation of depressions extending below surface level 503 may be due to the fact successive features are created, the laser beam is placed close enough to cause overlap of the beam shoulder with the beam shoulder of a previously heated track. The overlap area becomes depressed below the plane of the disk substrate while the portion in the beam center forms a protrusion by virtue of the higher temperature.

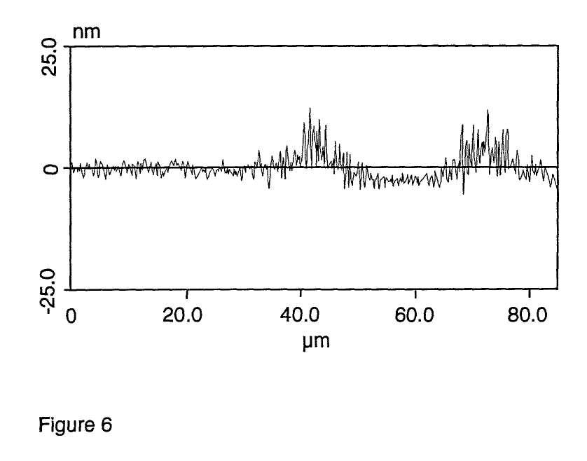

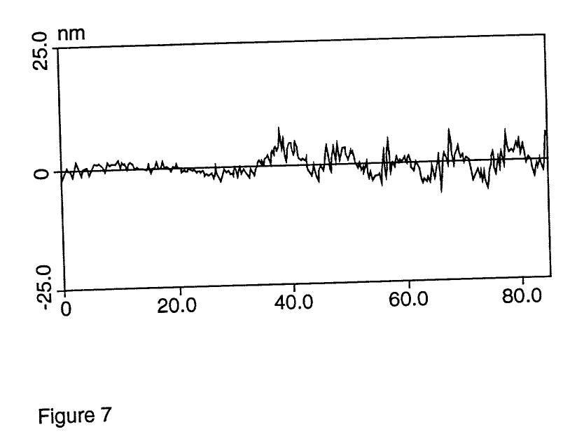

Referring again to FIG. 5, the center of protrusions 501 correspond to the incidence of the center of the laser beam. In FIG. 5, the center to center spacing of protrusions 501 is approximately 20 μm and the laser beam diameter is approximately 20 μm FWHM. Thus, in the specific case of FIG. 5, the beams used to form successive features overlapped at approximately the 50% intensity level. In general it is believed that overlap at or near this level will be particularly useful in reducing stiction, (particularly fly stiction), but other degrees of overlap may be used, depending upon the substrate material, characteristics of the beam and other factors. Similar texturing with the same beam diameter was also done at 30 μm spacing, as shown by FIG. 6 and at 10 μm spacing as shown by FIG. 7. The texturing was performed on the same type of substrate and using the same parameters (except radial spacing) as that shown in FIG. 5. Several observations may be made. Referring to FIG. 6, note that the depressions between the protrusions have greatly decreased. This is because under the given conditions, there is insufficient overlap between subsequent passes of the laser exposure. Consequently the depression cannot develop completely and hence the effective height (i.e. the height of the protrusion above the surface level plus the depth of the depression below the surface level) is too small to give an acceptable fly stiction value compared to features formed at 20 μm spacing for the particular embodiment of FIG. 5.

Referring to FIG. 7, texture features formed at a 10 μm radial spacing show that the features tend to merge such that the height of the positive protrusions and the depth of the depressions is reduced, thus reducing the amount of volume available for lube to flow from the head to the disk without causing a meniscus to form between the head and the disk. Therefore the fly stiction at 10 μm spacing is higher than that at 20 μm spacing. The merging of the features at 10 μm spacing can be explained by the fact that when the beam overlap is too great for a given diameter beam, the bump formation of overlapping features interferes too much and causes the features created by the two different exposures to partially or substantially annihilate each other and hence causes the effective feature height to be reduced. An analogous situation can be seen in the case of continuous exposure in the circumferential direction, which can be likened to numerous discrete features with minimal spacing in the circumferential direction. As can be seen for example in FIG. 2, there is no depression in the circumferential direction but rather only in the radial direction in between subsequent passes where the overlap is less. Therefore, to maximize the effective height of the feature for fly stiction performance a proper selection of spacing between successive laser pulses must be made.

As mentioned above, the 20 μm spacing provided the best stiction results for the particular system under investigation. It will be appreciated that in some cases, depending, for example on the amount of lubricant pick-up in the system, stiction requirements and other factors such as substrate material, beam power and beam diameter, other radial spacings might provide optimal results. For example, a 10 μm spacing might provide acceptable stiction results, and provide an even lower glide avalanche. In any event, it will be appreciated that one of skill in the art may form features using various laser texturing parameters, each at varying radial and/or circumferential spacings to determine the optimum spacing for a given set of conditions.

The unique texture feature with increased effective height formed by use of overlapping laser exposure can also be used in an embodiment having discrete laser features. As shown in FIG. 1, the optimum final stiction for a pattern of discrete bumps formed by the methods described in conjunction with FIG. 1 has a density of 20×20 which results in much lower stiction than either the 30×30 or 60×30 patterns for the 53 Å bump height. This is because the effective height of the 20×20 pattern is much higher than the others due to the overlap described herein.

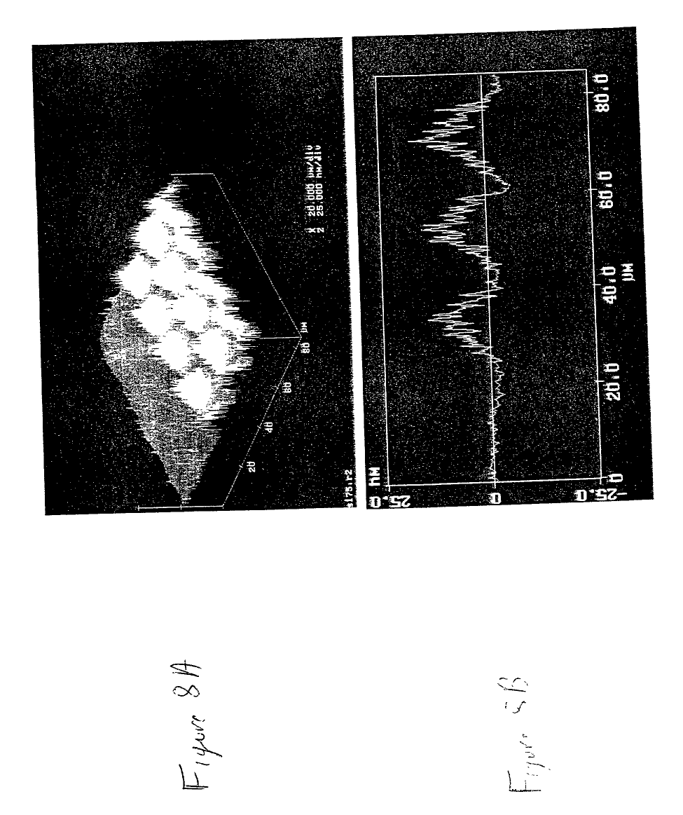

FIG. 8A shows a three dimensional AFM image of discrete bumps formed in a 20×20 pattern. FIG. 8B shows a two dimensional AFM image of the surface shown in FIG. 8A. Unlike the case of continuous features, for discrete features it is difficult to ensure that the scan of FIG. 8B precisely traverses the extreme peaks and extreme valleys of the features. Therefore, both the positive protrusions and negative depressions may have a greater dimension than that shown in FIG. 8B. Nevertheless, as can be discerned from the figure, the area between the positive protrusions is lower than that of the untextured area and hence increases the effective height of the feature. This is why the 20× 20 pattern has a better final stiction than the 30×30 pattern or 60×30 pattern in FIG. 1. The existence of the negative depressions between the laser bumps in both the radial and circumferential directions provides a good reservoir for lube collection and improves (i.e. lowers) the parking stiction and the fly stiction performance as demonstrated in the following two Figures.

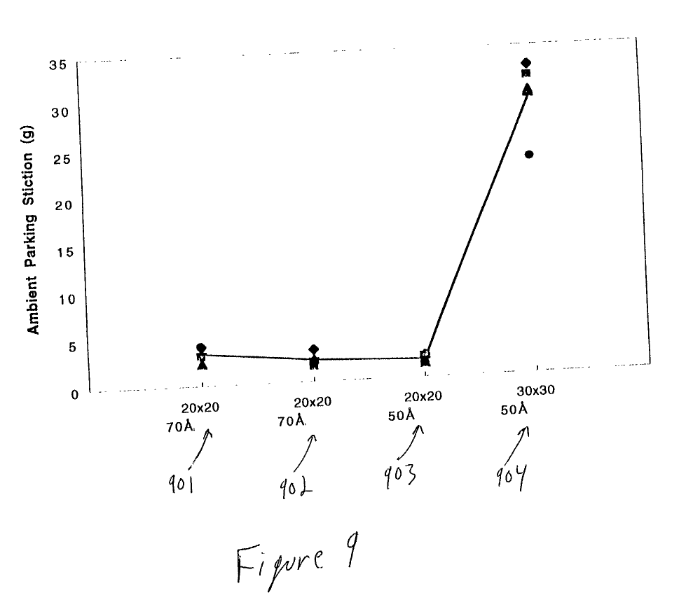

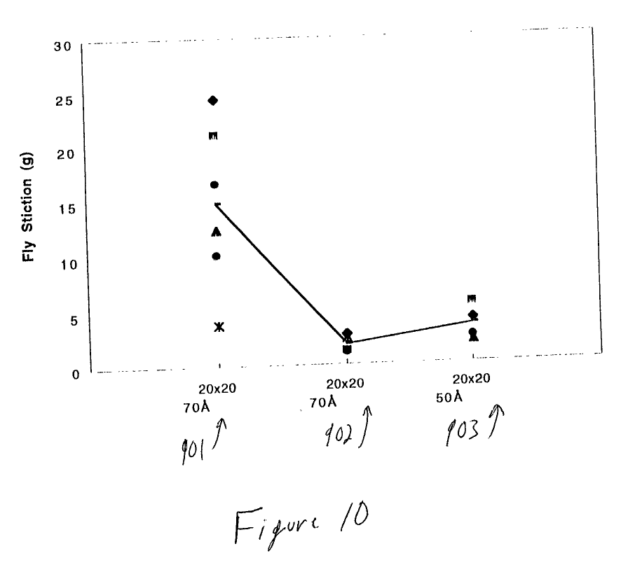

FIGS. 9 and 10 demonstrate the effect described above. FIG. 9 shows the parking stiction for three sets 901, 902 and 903 of laser textured disks having a 20×20 pattern of discrete bumps and one set 904 of laser textured disks having a 30×30 pattern of discrete bumps. FIG. 10 shows fly stiction results for the three sets 901, 902 and 903 having the 20×20 pattern.

In FIGS. 9 and 10, each position along the X axis shows a given set of substrates, while the parking stiction (FIG. 9) or fly stiction (FIG. 10) for each set of disks is shown along the Y axis. For all of the data in FIGS. 9 and 10, the substrate used was an Ohara TS-10 IV C SP. The substrates were textured using a beam diameter of 20 μm FWHM. The height of the texture features in sets 901 and 902 was approximately 70 Å, while the height of the texture features of sets 903 and 904 was approximately 50 Å. Set 901 was textured using a pulse width of 4 μs, while sets 902, 903 and 904 were textured using a pulse width of 1 μs.

Sets 902, 903 and 904 were textured with the substrate rotating such that the linear velocity was approximately 4 m/s while set 901 was textured with the substrate rotating at ¼this speed (approximately 1 m/s) to keep the spot geometry (spot drag) of the features the same as for the other sets of substrates. The spot drag is equal to the linear velocity times the pulse width divided by the spot size. The set of substrates 901 was textured using a power of approximately 1.0 W, while the set 902 was textured using a power of approximately 5.1 W, so that the resulting energy used for sets 901 and 902 was approximately 4.1 μJ and 5.5 μJ, respectively. Sets 903 and 904 were textured at a power of 4.9 W and therefore an energy of 4.9 μJ.

As can be seen from FIG. 9, the three sets of substrates 901, 902 and 903 all achieved excellent parking stiction results. In contrast, the set 904 had unacceptably high parking stiction. This is because the 30×30 pattern does not have sufficient overlap to provide the benefits of increased effective height described herein. In contrast, although set 903 has approximately the same bump height, the parking stiction is excellent due to overlap.

Referring now to FIG. 10, the three sets of substrates 901, 902 and 903 having acceptable parking stiction were tested for the more difficult fly stiction. As mentioned above, set 901 used a pulse width four times longer than that of the other sets of disks. As described earlier, it has been found that use of lower powers for a longer duration reduces or eliminates the micro-texture. Indeed, upon a visual inspection of one of the disks in the set 901, it was found that the bump surfaces were relatively smooth. The result of this, as can be seen from FIG. 10, is that there is a wide range of fly stiction results, with most being unacceptably high. In contrast, both sets 902 and 903 had micro-texture formed thereon and as can be seen the difficult to meet fly stiction was kept to very low levels. FIGS. 9 and 10 together show the benefits of both overlap and micro-texture. Furthermore, although the fly stiction of set 903 is slightly higher than that of set 902, it still remains relatively low, especially in light of the low protrusion height. Thus, the texturing method of the present invention remains extendible down to very low bump heights which will be required for acceptable stiction in low glide avalanche drives because of the effective height (positive protrusions plus negative depressions) is larger than the bump height and because of the presence of micro-texture.

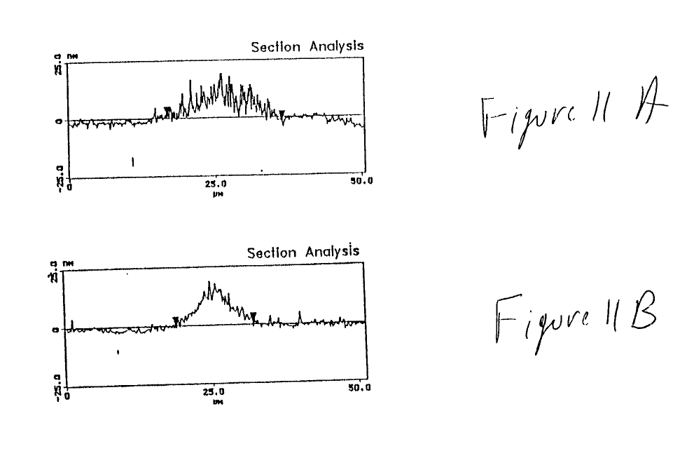

To demonstrate the power dependence of micro-texture, FIG. 11 shows two dimensional AFM profiles of two different discrete bumps formed using a beam diameter of 20 μm FWHM. The texture feature of FIG. 11A was formed using a pulse width of 1 μs, while the texture feature of FIG. 11B was formed using a pulse width of 20 μs. The substrate velocity for the texture feature of FIG. 11A was approximately 4 m/s and the energy was approximately 4.9 μJ. For FIG. 11B, the substrate velocity and energy were approximately 0.2 m/s and approximately 9 μJ, respectively. As can be clearly seen, the micro-texture is greatly reduced on FIG. 11B, again showing that shorter pulse widths generally result in increased micro-texture for the same energy. It will be appreciated that although a pulse width of 1 μs in the case of discrete features or an approximately equivalent energy fluence in the case of continuous features has formed micro-texture for the particular substrates and conditions described herein, other values of pulse width or other combinations of power and disk rotation speed may be used to form micro-texture depending upon the specific substrate material, beam diameter, laser characteristics and other conditions. Therefore, one of skill in the art will appreciate that for any given set of conditions, various pulse widths or power/disk rotation speed combinations should be investigated. In general, it is anticipated that for a specific set of conditions, shorter pulse widths or higher energy fluences will result in greater micro-texture.

Referring back to FIG. 2, the micro-texture or small features of the present invention can be seen to have a spike-like morphology. It will be understood that the spike-like appearance shown in FIG. 2 is greatly exaggerated by the fact that the scale in the height or z direction is on a scale of 20 nm per division while the scale in the x and y direction is on a scale of 20 μm per division. The micro-texture provides several beneficial effects. First, the micro-texture provides numerous very low surface area points of contact allowing head to disk contact over a very small total surface area compared with otherwise similar smooth features. As is well known, reducing the surface area of contact reduces stiction. Moreover, as shown by the excellent stiction results over extended testing, the present invention provides for enhanced wear resistance. It is believed that the present invention achieves this at least in part because the micro-texture provides numerous crevice-like regions between the spikes providing for increased surfaces and regions that may retain lubricant, thus ensuring sufficient lubricant over a long life. Because the lubricant is held on and between the crevices of the micro-texture, and because there are numerous points of contact between the micro-texture and the slider, a large meniscus does not form at the head to media contact surface. In contrast, in a prior art smooth feature, a large amount of lubricant would cause a large meniscus to form, which is known to increase parking and fly stiction.

As mentioned earlier, the micro-texture of the present invention is believed to be formed as crystallites of glass ceramic present in the substrate break through the surface when the glass phase is melted or softened while at least some of the crystallite phase remains solid during irradiation. It will be appreciated therefore that the stiction performance of the present invention may be modified by appropriate adjustment of the substrate material. For example, the number of crystallites and size of the crystallites may be varied. It is possible that as the number and/or size of crystallites are optimized, improved stiction results may be achieved with a lower equivalent bump height. In addition, it may be possible to get optimum stiction performance at a greater degree of overlap than discussed above with a sufficiently rough micro-texture. In such an embodiment the protrusion and depression heights (e.g. distances 507 and 508 of FIG. 5) may be minimized, thereby further lowering the glide avalanche height.

With periodic discrete features, the repetitive pressure disturbance to the air bearing surface or repetitive contact with the periodic features produces an undesirable vibration of the recording head. If the frequency of the bumps matches a resonance frequency of the slider body, this energy is additive, resulting in increased excitation of the slider body. Those embodiments of the invention comprising continuous features do not have the periodic pressure disturbance or periodic contact of regularly spaced features. Therefore, this resonance condition can be practically eliminated with the continuous features of the present invention.

It will be appreciated that although some embodiments of the present invention have been described in terms of continuous concentric or spiral type tracks, the use of overlap is also beneficial for discrete features as shown in FIGS. 8-10. Moreover, in embodiments that do utilize continuous features, there may be breaks in the features. In this regard, any elongation of the prior art bumps i.e. such that the length of the feature in the circumferential direction is greater than the width as in the prior art is beneficial. Thus for example, the present invention encompasses the use of multiple protrusions along a track which may be, for example, approximately 10% greater in the circumferential direction and more preferably 50% or more greater in the circumferential direction than the width. It will be appreciated that there is a trade off between stiction performance and wear with respect to continuous versus discrete features. Because discrete features have a smaller total contact area, stiction performance of discrete features may be better as compared with continuous features having similar effective height and micro-texture. Conversely, because the continuous features provide more micro-texture surface on which the slider rides, the micro-texture is likely to be less resistant to wear over time.

While the use of continuous laser features has the advantages described herein, it will be appreciated that particular advantage is achieved by the use of micro-texture in combination with the continuous feature. In particular, a continuous laser feature without the micro-texture of the present invention would have an increased surface area, thereby increasing stiction as compared to the continuous feature with the micro-texture. Alternatively, the benefits of continuous features may be achieved by using other means to achieve acceptable stiction results. For example, continuous features even with smooth surfaces may be used in conjunction with so called “stiction-free” sliders, which have some type of texturing such as a roughened surface, or features such as bumps, pads, or bars on the portion of the slider that contacts the disk in the CSS zone. Co-pending application Ser. No. 09/082,789 filed on May 21, 1998, which application is assigned to the assignee of the present invention, and which is hereby incorporated by reference, discloses use of a padded slider on a textured surface, including a laser textured surface. One concern in such an arrangement is to ensure that there is a sufficient density of texture features on the surface in contact with the pads on the slider. The use of the continuous feature together with the padded slider, particularly a slider having a bar type pad that extends across all or most of each rail ensures a consistent contact between the laser texture and the slider throughout the landing zone.

As a further alternative, continuous features may be formed on other types of substrates or on layers of various materials (such as NiP). Stiction may be reduced using a micro-texture formed by other means, such as chemical etching, for example. Such micro-texture may have a different morphology than that shown herein, but should be formed so as to reduce stiction to an acceptable level.

A further benefit of a continuous feature is increased flexibility in process design with respect to application of laser energy. Where it is desirable to form a discrete circular shaped bump, the flexibility in pulse width is limited due to spot drag. Although the disk speed could be reduced to reduce the spot drag, this increases through-put time. Alternatively, for circular bumps the disk could be stopped or slowed during application of the laser pulse, but such a system is generally considered unduly complex. In contrast, in forming continuous features the process can be tuned by adjusting the power and disk rotation speed, without regard to spot drag concerns.

As a further alternative the beneficial effects of continuous features may be achieved by placing numerous bump type features in close proximity in the circumferential direction so as to achieve a feature that approaches the continuous protrusion of FIG. 2. As noted in relation to FIGS. 8 and 9, discrete features may be formed with overlap of laser incidence in both the radial and circumferential direction to provide the described reservoir for lube and increased effective height. As a variation of the discrete features, the circumferential spacing may be reduced such that the feature approaches a continuous feature in the circumferential direction (i.e. the depth of depressions is reduced due to close overlap) while the radial spacing is adjusted for the desired height of the protrusion and depth of the depression.

While the invention has been described with respect to specific embodiments thereof, those skilled in the art will recognize that changes can be made in form and detail without departing from the spirit and scope of the invention. As described above, numerous parameters may be used to form features in accordance with the present invention. Although specific embodiments have been shown, aspects of any embodiment can be used in others. For example, any one or more of overlapping laser exposure, continuous features, micro-texture and stiction-free sliders may be used in various embodiments. The embodiments described herein, as well as embodiments having changes in form and detail as may be readily apparent to one of skill in the art upon reading the present disclosure are understood to come within the scope of the present invention.

What is claimed is:

1. A method of texturing a substrate comprising the steps of:
providing said substrate, said substrate comprising glass;
applying radiation to a surface of said substrate;
wherein said step of applying said radiation to said surface forms a texture feature on said surface, and wherein said step of applying said radiation is performed such that radiation is applied to a first portion of said substrate and to a second portion of said substrate, said second portion overlapping at least a part of said first portion.

2. The method as described in claim 1 wherein said substrate comprises a glass ceramic material.

3. The method as described in claim 1 wherein said texture feature comprises a protrusion extending from said substrate, said protrusion having micro-texture thereon.

4. The method as described in claim 3 wherein said micro-texture comprises micro-texture features have an average width at the base between approximately 0.05μ and 3μ and an average peak to valley distance between approximately 1 nm and 20 nm.

5. The method described in claim 1 further comprising providing relative motion between a point of incidence of said radiation and said surface of said substrate, wherein said radiation is applied during said relative motion and for a time sufficient to cause said feature to have a first dimension in a circumferential direction of said substrate greater than a second dimension in a radial direction of said substrate.

6. The method as described in claim 5 wherein said first dimension is such that said texture feature is formed in a shape selected from the group consisting of circular and spiral.

7. The method as described in claim 2 wherein said radiation causes a portion of said surface to be heated above a temperature sufficient to melt or soften a glass phase of said glass ceramic material but below a melting point of said glass ceramic material.

8. A substrate for use in manufacturing a magnetic recording disk comprising an area for landing a magnetic recording head thereon, said substrate comprising glass, said area comprising a region textured by application of a first beam of radiation, and wherein at least a portion of said region is textured by application of a second beam of radiation.

9. The substrate as described in claim 8 wherein said substrate has a surface, said surface having a surface level, wherein at least some of said textured region extends above said surface level and wherein at least some of said textured region extends below said surface level.

10. The substrate as described in claim 8 wherein said substrate comprises a glass ceramic material.

11. The substrate as described in claim 8 wherein said texture feature comprises a protrusion extending from said substrate, said protrusion having micro-texture thereon.

12. The substrate as described in claim 11 wherein said micro-texture comprises micro-texture features have an average width at the base between approximately 0.05μ and 3μ and an average peak to valley distance between approximately 1 nm and 20 nm.

13. The substrate as described in claim 10 wherein said radiation causes a portion of said surface to be heated above a temperature sufficient to melt or soften a glass phase of said glass ceramic material but below a melting point of said glass ceramic material.

14. The substrate as described in claim 8 wherein said feature has a first dimension in a circumferential direction of said substrate greater than a second dimension in a radial direction of said substrate, and wherein said first dimension is such that said texture feature is formed in a shape selected from the group consisting of circular and spiral.

15. A disk drive incorporating a disk fabricated using the substrate of claim 8.

16. A method of texturing a substrate comprising the steps of:
providing said substrate;
applying radiation to a surface of said substrate, wherein said substrate comprises a glass ceramic material;
providing relative motion between a point of incidence of said radiation and said surface of said substrate; and
wherein said step of applying said radiation to said surface forms a texture feature on said surface, wherein said texture feature comprises a protrusion extending from said substrate, said protrusion having micro-texture thereon, and wherein said step of applying said radiation to said surface is performed during said relative motion and for a time sufficient to cause said feature to have a first dimension in a circumferential direction of said substrate greater than a second dimension in a radial direction of said substrate.

17. The method as described in claim 16 wherein said micro-texture comprises micro-texture features having an average width at the base between approximately 0.05μ and 3μ and an average peak to valley distance between approximately 1 nm and 20 nm.

18. The method as described in claim 16 wherein said radiation causes a portion of said surface to be heated above a temperature sufficient to melt or soften a glass phase of said glass ceramic material but below a melting point of said glass ceramic material.

19. The method as described in claim 16 wherein said first dimension is 10 percent or more greater than said second dimension.

20. The method as described in claim 16 wherein said first dimension is 50 percent or more greater than said second dimension.

21. The method as described in claim 16 wherein said second dimension remains substantially constant for a distance in said circumferential direction.

22. The method as described in claim 16 wherein said texture feature is formed in a shape selected from the group consisting of circular and spiral.

23. A substrate for use in manufacturing a magnetic recording disk, said substrate comprising a glass ceramic material, said substrate further comprising a region for landing a magnetic recording head thereon, said region comprising at least one texture feature, said texture feature comprising a protrusion extending above a surface of said substrate, said protrusion having a first dimension in a circumferential direction of said substrate greater than a second dimension in a radial direction of said substrate, wherein said protrusion has micro-texture thereon.

24. The substrate as described in claim 23 wherein said micro-texture comprises micro-texture features having an average width at the base between approximately 0.05μ and 3μ and an average peak to valley distance between approximately 1 nm and 20 nm.

25. The substrate as described in claim 23 wherein said radiation causes a portion of said surface to be heated above a temperature sufficient to melt or soften a glass phase of said glass ceramic material but below a melting point of said glass ceramic material.

26. The substrate as described in claim 23 wherein said first dimension is 10 percent or more greater than said second dimension.

27. The substrate as described in claim 23 wherein said first dimension is 50 percent or more greater than said second dimension.

28. The substrate as described in claim 23 wherein said second dimension re mains substantially constant for a distance in said circumferential direction.

29. A disk drive incorporating a disk fabricated using the substrate of claim 23.

30. The substrate as described in claim 23 wherein texture feature is formed in a shape selected from the group consisting of circular and spiral.

31. A method of texturing a substrate comprising the steps of:
providing said substrate;
applying radiation to a surface of said substrate;
wherein said step of applying said radiation to said surface of said substrate forms a texture feature on said surface of said substrate, wherein said texture feature comprises a protrusion extending from said substrate, said protrusion having micro-texture thereon, and wherein said step of applying said radiation to said surface is performed to cause said feature to be substantially continuous for a distance in a circumferential direction.

32. The method as described in claim 31 wherein said substrate comprises a glass ceramic material.

33. The method as described in claim 31 wherein said small texture features have an average width at the base between approximately 0.05μ and 3μ and an average peak to valley distance between approximately 1 nm and 20 nm.

34. The method as described in claim 32 wherein said radiation causes a portion of said surface to be heated above a temperature sufficient to melt or soften a glass phase of said glass ceramic material but below a melting point of said glass ceramic material.

35. The method as described in claim 31 wherein said protrusion has a dimension in the radial dimension that remains substantially constant for a distance in said circumferential direction.

36. A substrate for use in manufacturing a magnetic recording disk comprising a region for landing a magnetic recording head thereon, said region comprising at least one texture feature, said texture feature comprising a protrusion extending above the surface of said substrate, wherein said protrusion is substantially continuous for a distance in a circumferential direction, said protrusion having micro-texture thereon.

37. The substrate as described in claim 36 wherein said substrate comprises a glass ceramic material.

38. The substrate as described in claim 36 wherein said micro-texture comprises micro-texture features have an average width at the base between approximately 0.05μ and 3μ and an average peak to valley distance between approximately 1 nm and 20 nm.

39. The substrate as described in claim 37 wherein said radiation causes a portion of said surface to be heated above a temperature sufficient to melt or soften a glass phase of said glass ceramic material but below a melting point of said glass ceramic material.

40. The substrate as described in claim 36 wherein said protrusion has a dimension in the radial dimension that remains substantially constant for a distance in said circumferential direction.

41. A system for storage of data comprising:
a disk capable of storing data said disk comprising a region for landing a magnetic recording head thereon, said region comprising at least one texture feature, said texture feature comprising a protrusion extending above a surface of said substrate, said protrusion having a first dimension in a circumferential direction of said substrate greater than a second dimension in a radial direction of said substrate;
a body comprising a magnetic head, said body having a landing surface, said landing surface in sliding contact with said region of said disk during at least a portion of an operation of said system, said system having a texture thereon such that some portions of said landing surface are at different elevation than other portions thereof.

42. The system as described in claim 41 wherein said texture of said landing surface comprises one or more of: pads, bumps and bars.

43. The system as described in claim 41 wherein said substrate comprising a glass ceramic material.

44. The system as described in claim 41 wherein said protrusion has micro-texture thereon.
